(19) United States
(12) Patent Application Publication
(10) Pub. No.: US 2018/0210681 A1
(43) Pub. Date: Jul. 26, 2018

(54) IMAGE FORMING SYSTEM AND IMAGE FORMING METHOD

(71) Applicant: KYOCERA Document Solutions Inc., Osaka (JP)

(72) Inventor: Carl Christian Ray PANTIN, Osaka (JP)

(73) Assignee: KYOCERA Document Solutions Inc., Osaka (JP)

(21) Appl. No.: 15/857,910

(22) Filed: Dec. 29, 2017

(30) Foreign Application Priority Data
Jan. 20, 2017 (JP) 2017-008702

(51) Int. Cl. G06F 3/12; H04N 1/00; H04N 1/21

(52) U.S. Cl. CPC G06F 3/1204; H04N 1/00278; H04N 1/00175; H04N 1/00188; H04N 2201/0087; G06F 3/1284; H04N 1/2158; H04N 2201/0015; G06F 3/1206

(57) ABSTRACT

An image forming system includes an information processing apparatus and an image forming apparatus. The information processing apparatus includes a printing job generation unit that generates, on a basis of document data, a printing job including data of a printing condition for a printing operation to be executed by the image forming apparatus, a data writing unit that writes, in the external memory, an auto-run program for causing the image forming apparatus to automatically execute the printing operation, and the printing job, and a first controller that controls the data writing unit. The image forming apparatus includes a data reading unit that retrieves the auto-run program and the printing job from the external memory, and a second controller that causes the printing unit to execute the printing operation based on the retrieved printing job, according to the retrieved auto-run program.

### INCORPORATION BY REFERENCE

This application claims priority to Japanese Patent Application No. 2017-008702 filed on Jan. 20, 2017, the entire contents of which are incorporated by reference herein.

### BACKGROUND

The present disclosure relates to an image forming system and an image forming method, and more particularly to a technique to cause an image forming apparatus to automatically perform a printing operation, with the intermediation of an external memory.

Some of image forming apparatuses recently developed include an external terminal to which an external memory such as a USB memory can be connected. In such an image forming system, the user can store the data used for a printing operation by the image forming apparatus in the external memory in advance, and then connect the external memory to the external terminal, to thereby cause the image forming apparatus to read the data from the external memory and perform the printing operation according to the data.

Regarding the image forming system, some techniques have been proposed to store an auto-run program, for causing the image forming apparatus to automatically perform the printing operation, in the external memory in advance, so as to cause the image forming apparatus, when the external memory is connected to the external terminal of the image forming apparatus, to automatically perform the printing operation according to the auto-run program read by the image forming apparatus. According to one of such techniques, for example, only unprinted data in the USB memory is extracted, and the printing operation is automatically performed using the extracted data. According to another technique, a file is detected from the USB memory connected to the image forming apparatus and analyzed, to thereby automatically identify the language and acquire a print setting (printing condition) from the file, and then the printing operation is automatically performed, according to the acquired printing condition.

### SUMMARY

The disclosure proposes further improvement of the foregoing technique.

In an aspect, the disclosure provides an image forming system including an information processing apparatus and an image forming apparatus. The information processing apparatus includes a printing job generation unit that generates, on a basis of document data, a printing job including data of a printing condition for a printing operation to be executed by the image forming apparatus, a memory terminal to which an external memory is connected, a data writing unit that writes, in the external memory connected to the memory terminal, an auto-run program for causing the image forming apparatus to automatically execute the printing operation, and the printing job, and a first controller that controls the data writing unit. The image forming apparatus includes a printing unit that executes the printing operation on a recording medium, an external terminal to which the external memory is connected, a data reading unit that retrieves the auto-run program and the printing job from the external memory, when the external memory is connected to the external terminal, and a second controller that causes the printing unit, when the data reading unit retrieves the auto-run program and the printing job, to execute the printing operation based on the retrieved printing job, according to the retrieved auto-run program.

In another aspect, the disclosure provides an image forming method to be executed by an image forming system including an information processing apparatus and an image forming apparatus. The method includes steps of generating, writing, reading, and printing. The generating step includes generating, on a basis of document data, a printing job including data of a printing condition for a printing operation to be executed by the image forming apparatus. The writing step includes writing, in an external memory, an auto-run program for causing the image forming apparatus to automatically execute the printing operation, and the printing job. The reading step includes reading the auto-run program and the printing job from the external memory, into the image forming apparatus. The printing step includes executing the printing operation based on the retrieved printing job, according to the retrieved auto-run program.

### BRIEF DESCRIPTION OF THE DRAWINGS

FIG. 1 is a schematic drawing showing an overall configuration of an image forming system according to a first embodiment of the disclosure.

FIG. 2 is a functional block diagram showing an essential part of a PC.

FIG. 3 is a functional block diagram showing an essential part of an image forming apparatus.

FIG. 4 is a schematic drawing showing a specific example of printing jobs stored in a storage region of a USB memory.

FIG. 5 is a flowchart showing a process performed by the PC.

FIG. 6 is a flowchart showing a process performed by the image forming apparatus.

FIG. 7 is a schematic drawing showing an example of a screen displayed on a display unit of the PC.

FIG. 8 is a schematic drawing showing another example of the screen displayed on a display unit of the PC.

FIG. 9 is a schematic drawing showing an example of data stored in the storage region of the USB memory.

FIG. 10 is a schematic drawing showing an example of a screen displayed on a display unit of the image forming apparatus.

FIG. 11 is a flowchart showing a process performed by an image forming apparatus according to a second embodiment.

FIG. 12 is a schematic drawing showing an example of a screen displayed on the display unit of the image forming apparatus.

### DETAILED DESCRIPTION

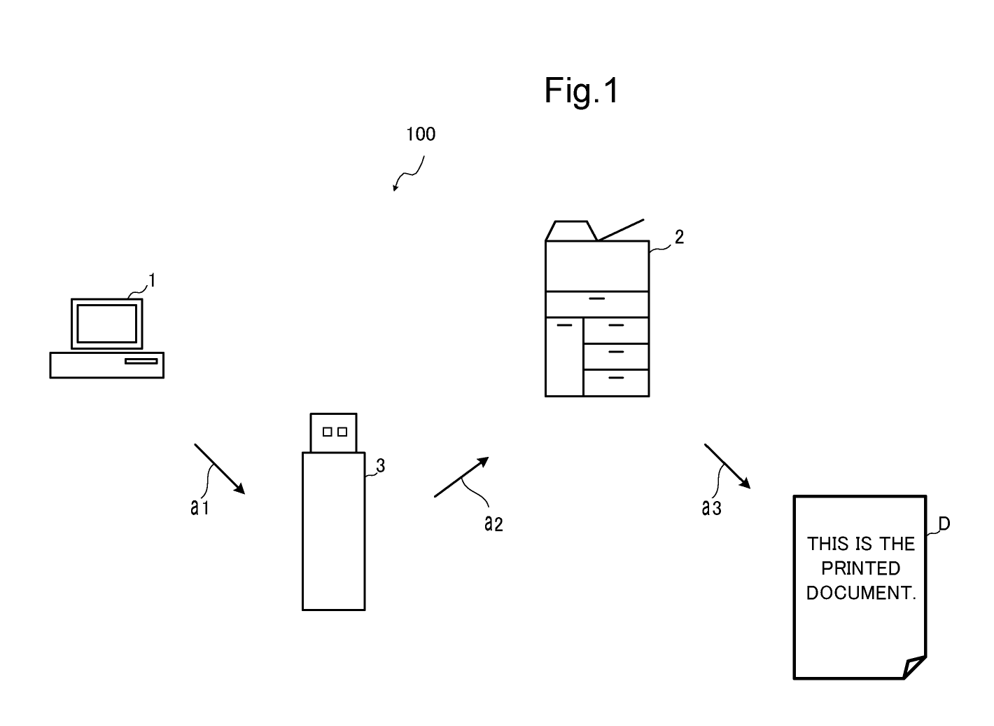

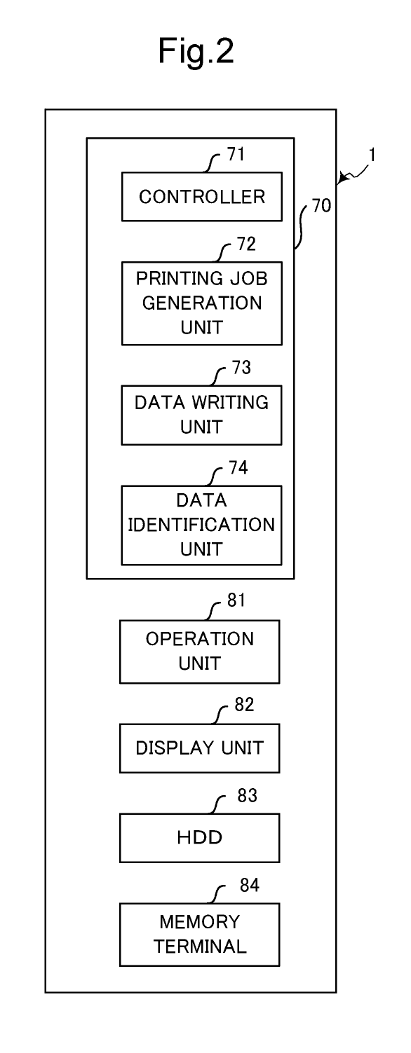

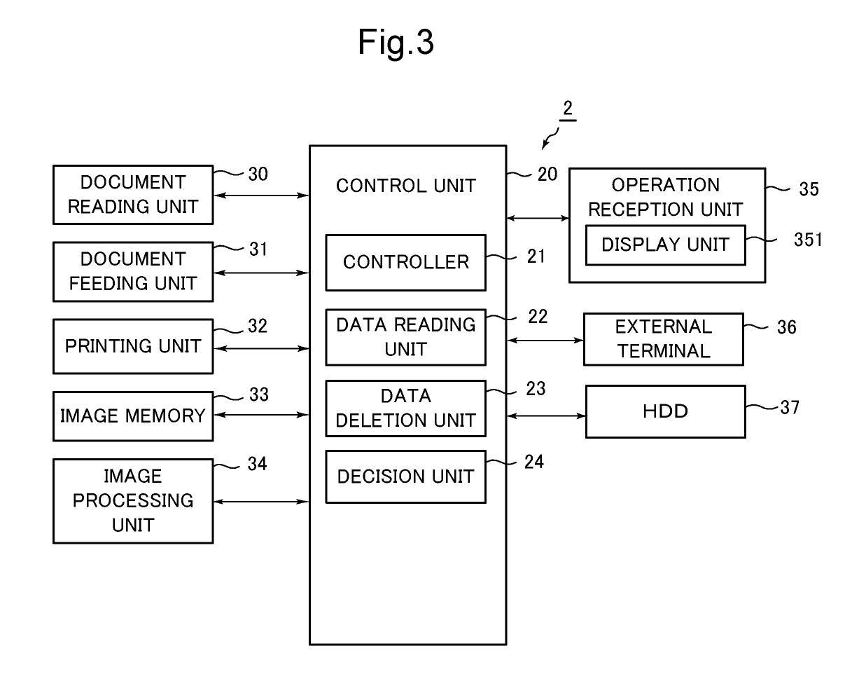

Hereafter, an image forming system and an image forming method according to embodiments of the disclosure will be described, with reference to the drawings. FIG. 1 is a schematic drawing showing an overall configuration of the image forming system according to a first embodiment of the disclosure. FIG. 2 is a functional block diagram showing an essential part of a personal computer (hereinafter, PC). FIG. 3 is a functional block diagram showing an essential part of an image forming apparatus.

The image forming system 100 includes a PC 1 corresponding to the information processing apparatus in the disclosure, and an image forming apparatus 2. Between the PC 1 and the image forming apparatus 2, a printing job generated by the PC 1 is inputted to the image forming apparatus 2 through a USB memory 3, corresponding to the external memory in the disclosure, to be utilized for the printing operation executed by the image forming apparatus 2.

More specifically, in the image forming system 100, the printing job generated in the PC 1 by the operation of the user is stored in the USB memory 3 from the PC 1, according to the operation of the user, as indicated by a1 in FIG. 1. The USB memory 3 also contains, as will be subsequently described in detail, auto-run program for causing the image forming apparatus 2 to automatically execute the printing operation, in addition to the printing job.

In the image forming system 100, when the USB memory 3 is connected to the image forming apparatus 2 selected by the user, the auto-run program and the data of the printing job are transmitted from the USB memory 3 to the image forming apparatus 2, as indicated by a2 in FIG. 1, and read by the image forming apparatus 2. Then the image forming apparatus 2 operates according to the auto-run program read as above, to thereby automatically execute the printing operation based on the printing job read as above, and to generate a printed material D as indicated by a3 in FIG. 1. Thus, with the image forming system 100 according to this embodiment, the user can cause the image forming apparatus 2 to automatically execute the printing operation based on the printing job stored in the USB memory 3 in advance, and obtain the printed material D, simply by connecting the USB memory 3 to the image forming apparatus 2 that the user intends to use for the printing.

The PC 1 includes a control unit 70, an operation unit 81, a display unit 82, a HDD 83, and a memory terminal 84. The mentioned components are configured to transmit and receive data and signals to and from each other, via a CPU bus. The control unit 70 includes a processor, a random-access memory (RAM), and a read-only memory (ROM). The processor may be, for example, a central processing unit (CPU), a micro processing unit (MPU), or an application specific integrated circuit (ASIC). The control unit 70 acts as a controller 71, a printing job generation unit 72, a data writing unit 73, and a data identification unit 74, when the processor executes a print request control program stored in the HDD 83. Here, the controller 71, the printing job generation unit 72, the data writing unit 73, and the data identification unit 74 of the control unit 70 may each be constituted of a hardware circuit, instead of being realized by the operation based on the print request program. This also applies to other embodiments, unless otherwise specifically noted. The operation unit 81, the display unit 82, and the controller 71 respectively exemplify the first operation reception unit, the first display unit, and the first controller, in the disclosure.

The controller 71 serves to control the overall operation of the PC 1.

The controller 71 also reads document data stored in the HDD 83, or reads document data from outside of the PC 1, for example a server connected via a network such as LAN to a communication module of the PC 1 such as a LAN board, according to the operation of the user made through the operation unit 81.

The document data includes, for example, a file created by applications executed by the PC 1 such as a word processor, a spreadsheet software, and a drawing software, and image data such as jpeg. It will be assumed, however, that such document data are not yet converted into a format compatible with the image forming apparatus 2 and the printing operation thereby, and hence unable to be directly utilized for the printing operation by the image forming apparatus 2.

The printing job generation unit 72 generates the printing job for the printing operation by the image forming apparatus 2, from the document data. In other words, the printing job generation unit 72 generates the printing job (e.g., a PRN file), from the document data read by the controller 71. More specifically, the printing job generation unit 72 operates according to the printer driver stored in the HDD 83, so as to convert the document data into a format including the printer language compatible with the image forming apparatus 2, thus generating print data, and generates the printing job for the printing operation, including such print data. The printing job also includes data of printing condition for the printing operation, specifying, for example, color printing, monochrome printing, and print size, in addition to the print data. Such data of the printing condition is designated by the operation of the user made through the operation unit 81, and the printing job generation unit 72 adds the data of the designated printing condition to the printing job.

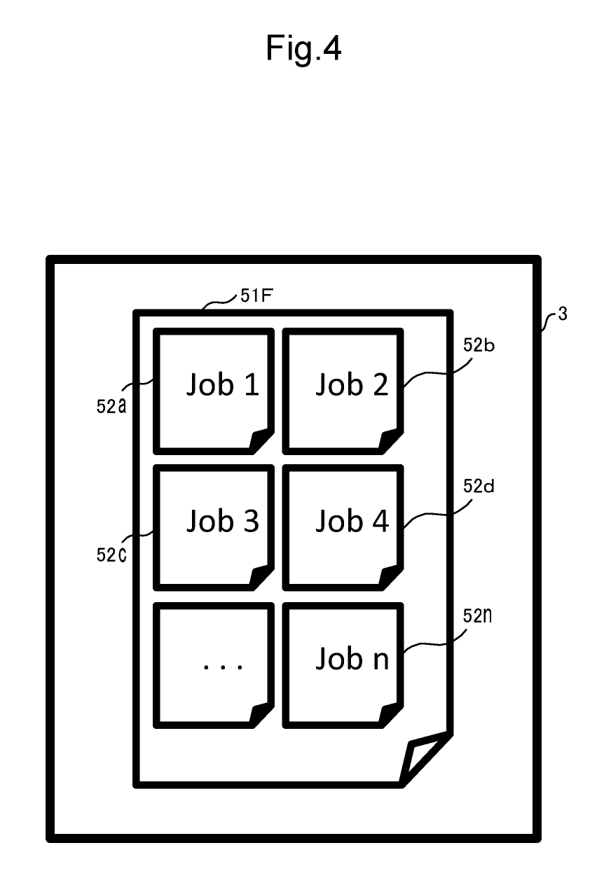

The data writing unit 73 collectively writes in a print execution file in the USB memory 3, when the USB memory 3 is connected to the memory terminal 84, the auto-run program stored in the HDD 83 in advance, and the printing job generated by the printing job generation unit 72, according to the operation of the user made through the operation unit 81. Accordingly, a print execution file 51F, including n pieces (n=an integer not smaller than 1) of printing jobs 52a to 52n, is stored in a storage region of the USB memory 3, as illustrated in FIG. 4. Here, the data writing unit 73 stores, as will be subsequently described in detail, a print execution folder including the print execution file 51F in the storage region of the USB memory 3, as a hidden folder.

In addition, when an instruction to delete the auto-run program and the printing job is inputted by the user through the operation unit 81, after a printing unit 32 of the image forming apparatus 2, to be subsequently described, has finished the printing operation based on the printing job, the data writing unit 73 collectively writes, under the control of the controller 71, the auto-run program, including the deletion command instructing to delete the auto-run program and the printing job from the USB memory 3 after the printing operation based on the printing job is finished, and the printing job, in the print execution file in the USB memory 3.

The data identification unit 74 makes access to the USB memory 3, when the data writing unit 73 writes the auto-run program and the printing job in the USB memory 3, and decides whether another print execution file, in other words another set of the auto-run program and the printing job is already stored in the USB memory 3.

The operation unit 81 includes a keyboard and a mouse, or a touch panel, for the user to input, for example, an instruction designating the document data to be printed.

The display unit 82 is constituted of a liquid crystal display (LCD) or the like, and displays various types of information such as a guidance for the user. The display unit 82 also includes a non-illustrated touch panel. Here, the display unit 82 including the touch panel exemplifies the first operation reception unit in the disclosure.

The image forming apparatus 2 is a multifunction peripheral having a plurality of functions, such as copying, printing, scanning, and facsimile transmission. The image forming apparatus 2 includes a control unit 20. The control unit 20 is composed of a CPU, a RAM, a ROM, and an exclusive hardware circuit, and serves to control the overall operation of the image forming apparatus 2.

The image forming apparatus 2 includes a document reading unit 30, a document feeding unit 31, a printing unit 32, an image memory 33, an image processing unit 34, an operation reception unit 35, an external terminal 36, and a HDD 37. Here, the operation reception unit 35 exemplifies the second operation reception unit in the disclosure.

The operation reception unit 35 receives instructions from the user to execute, for example, the image forming and the document reading, with respect to the operations and processes that the image forming apparatus 2 is configured to perform. The operation reception unit 35 includes a display unit 351 for displaying various types of information such as an operation guide for the user and an image for notifying occurrence of paper jam. The display unit 351 includes a non-illustrated LCD having a touch panel function. Here, the display unit 351 exemplifies the second display unit in the disclosure.

When the image forming apparatus 2 performs the document reading operation, the document reading unit 30 optically reads the image on a source document delivered from the document feeding unit 31, and generates image data.

When image forming apparatus 2 executes the image forming operation (i.e., printing operation), a controller 21 of the control unit 20, to be subsequently described, causes the printing unit 32 to execute the printing operation according to the image data generated through the document reading operation, or the printing job read by a data reading unit to be subsequently described, on a recording sheet, an example of a recording medium, delivered from a non-illustrated paper feed unit, to thereby form an image on the recording sheet.

The document reading unit 30 includes a non-illustrated reading mechanism including a light emitting unit and a CCD sensor, to be controlled by the control unit 20. The document reading unit 30 illuminates the source document with the light emitting unit and detects the reflected light with the CCD sensor, to thereby read the image from the source document and generate the image data.

The image memory 33 includes a region for temporarily storing the image data of the source document acquired by the document reading unit 30, and data for the printing operation, to be printed by the printing unit 32.

The image processing unit 34 acquires the image read by the document reading unit 30, from the image memory 33, and processes the acquired image. For example, the image processing unit 34 performs a predetermined image processing such as shading correction, to improve the quality of the image to be obtained after the printing unit 32 prints the image read by the document reading unit 30.

The printing unit 32 executes the printing operation of the image data read by the document reading unit 30, or print data converted by a conversion unit to be subsequently described and downloaded. More specifically, for example when the printing unit 32 is to perform color printing, an image forming subunit for magenta, an image forming subunit for cyan, an image forming subunit for yellow, and an image forming subunit for black in the printing unit 32 each form a toner image based on the corresponding color component, on a photoconductor drum through charging, exposing, and developing processes, and the toner image is transferred onto a non-illustrated intermediate transfer belt, via a primary transfer roller.

The toner images of the respective colors are superposed at an adjusted timing when transferred onto the intermediate transfer belt, so as to form a colored toner image. A secondary transfer roller transfers the colored toner image formed on the surface of the intermediate transfer belt onto a non-illustrated recording sheet transported along a transport route from the paper feed unit, at a nip region of a drive roller engaged with the intermediate transfer belt. Then a non-illustrated fixing unit fixes the toner image on the recording sheet by thermal compression. The recording sheet, having the colored image formed and fixed thereon, is discharged to a non-illustrated output tray.

To the external terminal 36, the USB memory 3 may be connected by the user, if need be.

The hard disk drive (HDD) 37 is a large-capacity storage device for storing, for example, source images acquired by the document reading unit 30.

The control unit 20 serves to control the overall operation of the image forming apparatus 2. The control unit 20 includes a controller 21, a data reading unit 22, a data deletion unit 23, and a decision unit 24. Here, the controller 21 exemplifies the second controller in the disclosure.

The control unit 20 includes a processor, a random-access memory (RAM), and a read-only memory (ROM), among which the processor is, for example, a CPU, a MPU, or an ASIC. The control unit 20 acts as the controller 21, the data reading unit 22, the data deletion unit 23, and the decision unit 24, when the processor executes a print execution program stored in the HDD 37. Here, the controller 21, the data reading unit 22, the data deletion unit 23, and the decision unit 24 may each be constituted of a hardware circuit, instead of being realized by the operation based on the control program. This also applies to other embodiments, unless otherwise specifically noted.

The controller 21, which serves to control the overall operation of the image forming apparatus 2, is connected to the document reading unit 30, the document feeding unit 31, the printing unit 32, the image memory 33, the operation reception unit 35, the external terminal 36, and the HDD 37, to control the operation of the mentioned components.

When the data reading unit 22 retrieves the auto-run program and the printing job (print data) from the USB memory 3 connected to the external terminal 36, the controller 21 causes the printing unit 32 to execute the printing operation based on the printing job, according to the auto-run program.

The data deletion unit 23 makes access to the USB memory 3 and deletes the data stored therein, under the control of the controller 21. More specifically, when the deletion command is detected from the auto-run program retrieved by the data reading unit 22, the data deletion unit 23 deletes the auto-run program and the printing job, from the USB memory 3. For example, the data deletion unit 23 overwrites the auto-run program and the printing job with predetermined meaningless data, to thereby delete the auto-run program and the printing job.

The decision unit 24 decides whether the printing unit 32 can execute the printing operation, on the basis of the printing condition included in the printing job retrieved by the data reading unit 22.

In the image forming system 100, further, the following image forming method is performed. The image forming method includes, on the side of the PC 1, a generating step including generating, on the basis of the document data, the printing job including the data of the printing condition for the printing operation by the image forming apparatus 2, and a writing step including writing, in the USB memory 3, the auto-run program for causing the image forming apparatus 2 to automatically execute the printing operation, and the printing job.

The image forming method also includes, on the side of the image forming apparatus 2, a reading step including reading the auto-run program and the printing job from the USB memory 3, and a printing step including executing the printing operation based on the printing job that has been read, according to the auto-run program that has been read. Further details will be subsequently described.

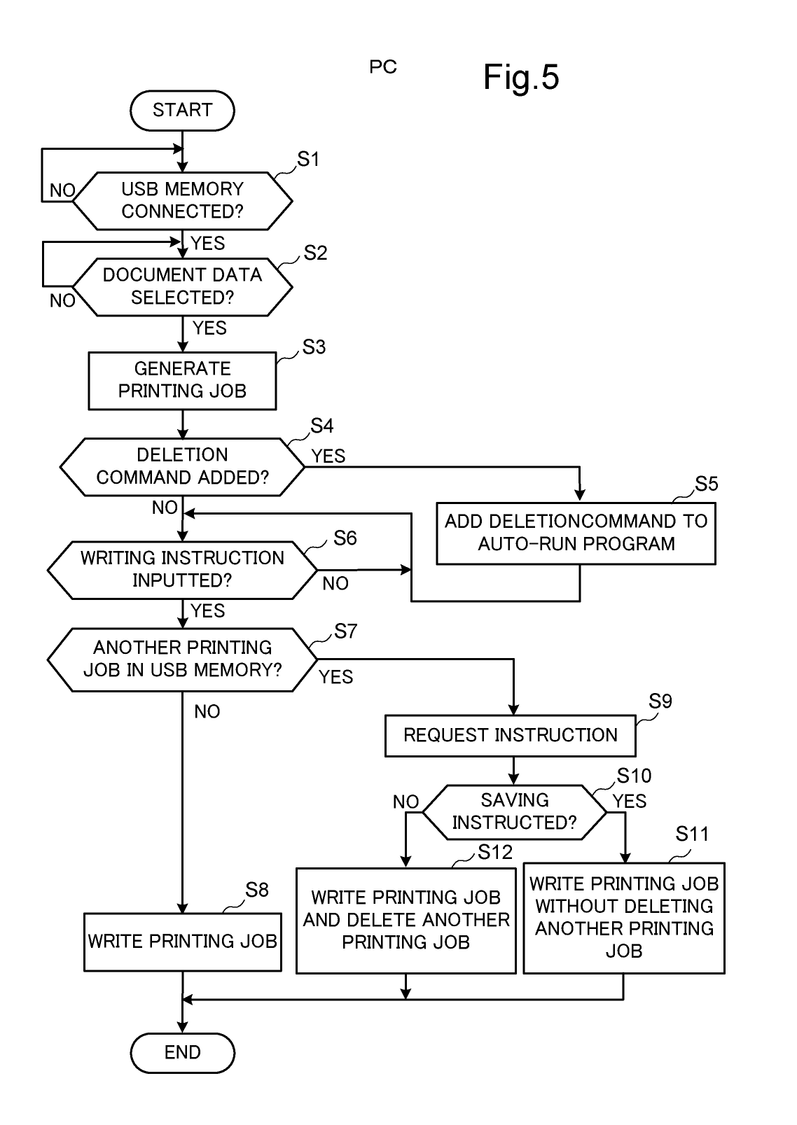

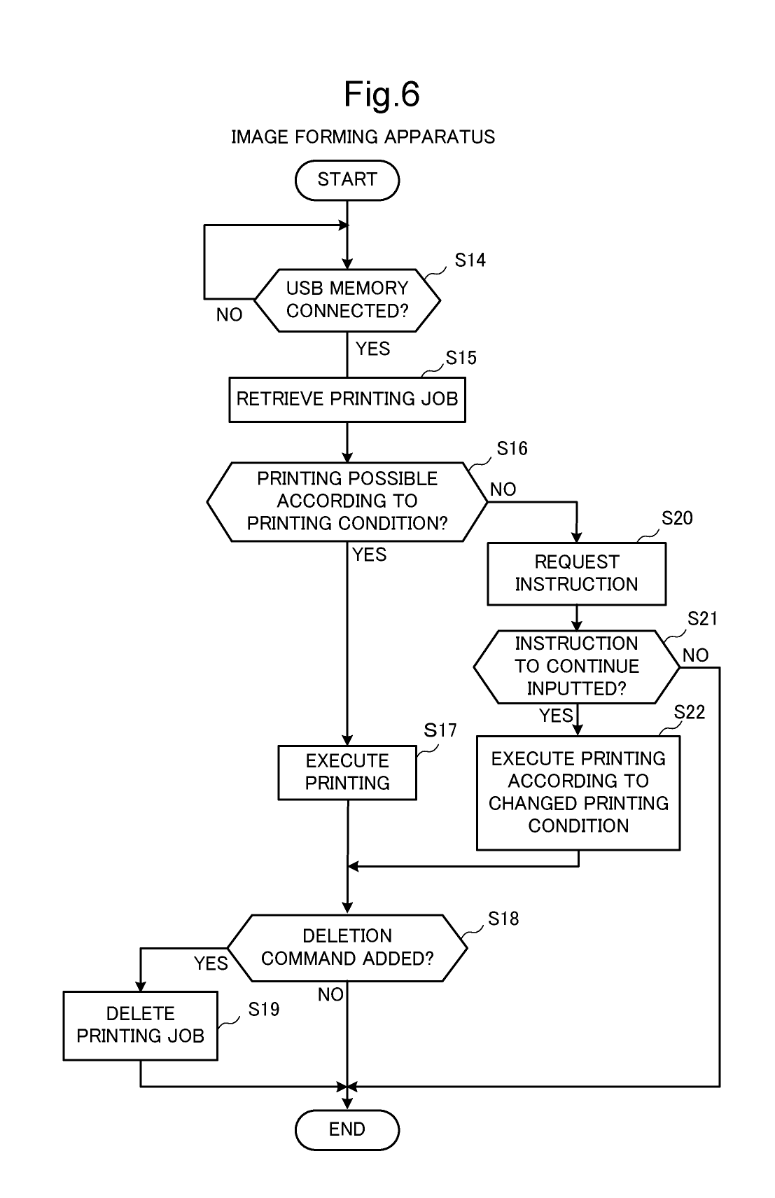

Hereunder, an operation of the image forming system 100 according to this embodiment will be described in detail. FIG. 5 is a flowchart showing a process performed by the PC. FIG. 6 is a flowchart showing a process performed by the image forming apparatus. The description give hereunder primarily focuses on the printing operation by the image forming apparatus 2, performed with the intermediation of the USB memory 3.

The controller 71 decides whether the USB memory 3 is connected to the memory terminal 84 (S1). Upon deciding that the USB memory 3 is not connected to the memory terminal 84 (NO at S1), the controller 71 sets the PC 1 to a standby mode.

In contrast, in the case of deciding that the USB memory 3 is connected to the memory terminal 84 (YES at S1), the controller 71 decides whether the document data has been selected from the HDD 83, by the operation of the user made through the operation unit 81 (S2). When the controller 71 decides that the document data has not been selected (NO at S2), the operation of S2 is repeated.

In contrast, when the controller 71 decides that the user has selected the document data to store the data to be printed in the USB memory 3 (YES at S2), the printing job generation unit 72 generates the printing job for the printing operation by the image forming apparatus 2, from the selected document data (S3: generating step).

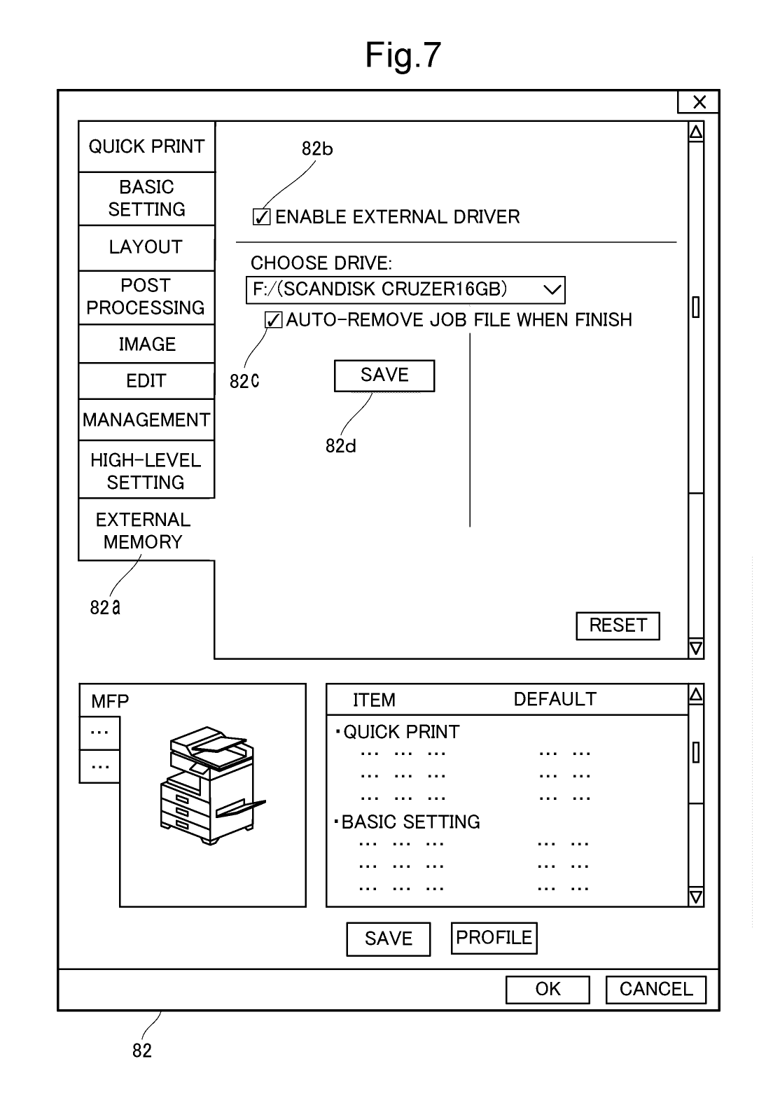

When the user inputs an activation instruction to the PC 1 through the operation unit 81, so as to cause the controller 71 to activate the printer driver, the controller 71 causes the display unit 82 to display an input screen, in which the tab of an external memory 82a is selected, as shown in FIG. 7. Then, upon detecting that a box 82b for selecting “ENABLE EXTERNAL DRIVER” in the input screen has been checked by the user through the operation unit 81, the controller 71 selects the USB memory 3 connected to the memory terminal 84, as destination for writing the printing job generated at S3.

Then the controller 71 causes the display unit 82 to display, when the data writing unit 73 is to write the auto-run program and the printing job in the USB memory 3, a message urging the user to instruct whether to delete the auto-run program and the printing job from the USB memory 3, after the printing unit 32 of the image forming apparatus 2 finishes the printing operation based on the printing job. In other words, the controller 71 decides whether to add the deletion command, to delete the auto-run program and the printing job from the USB memory 3 after the printing operation based on the printing job is finished, to the auto-run program in the USB memory 3 (S4).

For example, the controller 71 prepares a box 82c of “Auto-Remove Job File when Finish” in the input screen (see FIG. 7), and detects whether the box 82c has been checked by the user through the operation unit 81, to thereby decide whether to add the deletion command to the auto-run program. In the case where the controller 71 detects that the box 82c has not been checked (NO at S4), the operation proceeds to S6.

In contrast, in the case of detecting that the box 82c has been checked (YES at S4), the controller 71 adds the deletion command to the auto-run program stored in advance in the HDD 83 (S5). Thus, the controller 71 stores the auto-run program accompanied by the deletion command in the HDD 83, apart from the auto-run program without the deletion command, and causes the HDD 83 to retain these programs.

The controller 71 then decides whether the user has inputted an instruction to write the printing job in the USB memory 3 (S6). For example, the controller 71 decides whether a SAVE key 82d has been pressed by the user, in the display screen shown in FIG. 7. Unless the controller 71 detects that the user has pressed the SAVE key 82d (NO at S6), the controller 71 sets the PC 1 to the standby mode.

In contrast, in the case of detecting that the user has pressed the SAVE key 82d (YES at S6), the controller 71 decides that the user has determined the printing job for the printing operation by the image forming apparatus 2, and permitted to write the printing job in the USB memory 3.

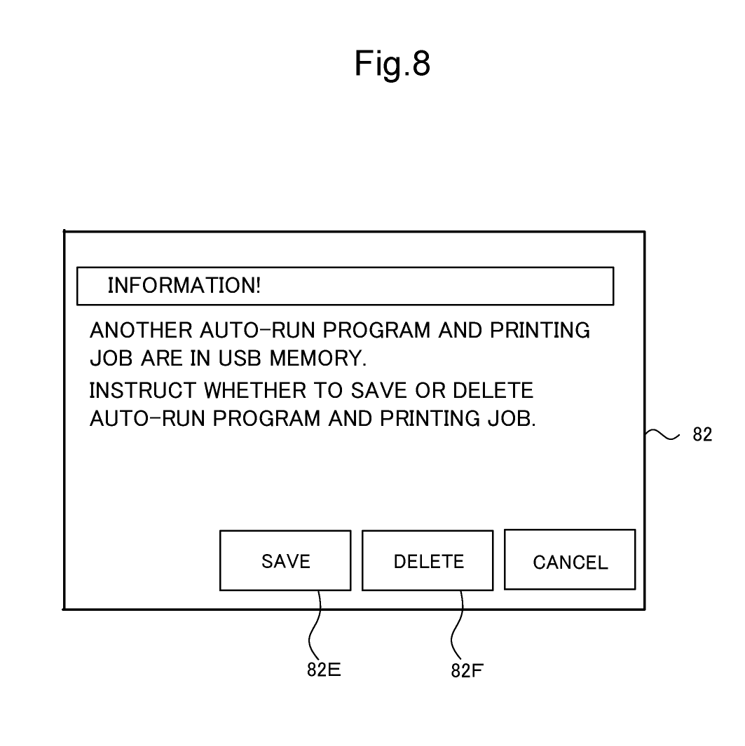

Then, the data identification unit 74 makes access to the USB memory 3, to decide whether another auto-run program and printing job are already stored in the USB memory 3 (S7). In the case where the data identification unit 74 decides that another auto-run program and printing job are not stored yet in the USB memory 3 (NO at S7), the controller 71 causes the data writing unit 73 to collectively write the auto-run program and the printing job in the print execution file in the USB memory 3, without causing the display unit 82 to display an input screen (see FIG. 8) to be subsequently described (S8: writing step). Here, when the data writing unit 73 writes the data as above, the auto-run program accompanied by the deletion command is written in the USB memory 3 in the case where the user has instructed to add the deletion command at S4, and the auto-run program without the deletion command is written, in the case where the user has not instructed to add the deletion command. This also applies to S11 and S12 to be subsequently described.

In the case where the data identification unit 74 decides that another auto-run program and printing job are already stored in the USB memory 3 (YES at S7), the controller 71 causes the display unit 82 to display a message requesting an instruction whether to save or delete the other auto-run program and printing job (S9).

For example, the controller 71 causes the display unit 82 to display, as shown in FIG. 8, a message to the effect that another auto-run program and printing job are already stored in the USB memory 3, and a message requesting the instruction whether to save the other auto-run program and printing job in the USB memory 3. Here, the display screen shown in FIG. 8 may display the number of printing jobs already stored in the USB memory 3, to notify such data to the user.

Then the controller 71 decides whether the user has instructed to save the other auto-run program and printing job already stored in the USB memory 3 (S10). For example, the controller 71 decides whether the user has pressed a SAVE key 82E or a DELETE key 82F, in the display screen shown in FIG. 8. Upon detecting that the user has pressed the SAVE key 82E (YES at S10), the controller 71 decides that the user has instructed to save the other auto-run program and printing job. Thereafter, the data writing unit 73 writes the auto-run program and the printing job generated at S3, in the USB memory 3, without deleting the other auto-run program and printing job from the USB memory 3 (S11: writing step).

More specifically, the data writing unit 73 writes the new auto-run program and printing job in another storage region in the USB memory 3, different from the storage region where the other auto-run program and printing job is stored, thus to store the new auto-run program and printing job, without deleting the other auto-run program and printing job. Further, in the case where the other auto-run program and printing job and the new auto-run program and printing job are thus stored in the USB memory 3, the printing operation of these printing jobs different from each other can be executed when the USB memory 3 is connected to the image forming apparatus 2, without the need to force the user to operate the image forming apparatus 2, and the printed materials produced from those printing jobs can be provided to the user.

In contrast, in the case of detecting that the user has pressed the DELETE key 82F (NO at S10), the controller 71 decides that the user has instructed to delete the other auto-run program and printing job. Then, the data writing unit 73 writes the auto-run program and the printing job generated at S3 in the USB memory 3, and at the same time deletes the other auto-run program and printing job therefrom (S12: writing step). Here, the controller 71 may cause the display unit 82, after detecting that the user has pressed the DELETE key 82F, to display a message urging the user to select which of the printing jobs should be deleted.

More specifically, in the storage region of the USB memory 3 where the other auto-run program and printing job are stored, the data writing unit 73 overwrites the other auto-run program and printing job with the new auto-run program and printing job, thus deleting the other auto-run program and printing job and storing the new auto-run program and printing job. When only the new auto-run program and printing job are stored in the USB memory 3 as above, the printing operation of the new printing job is automatically executed when the USB memory 3 is connected to the image forming apparatus 2, and only the printed material produced from the new printing job can be provided to the user.

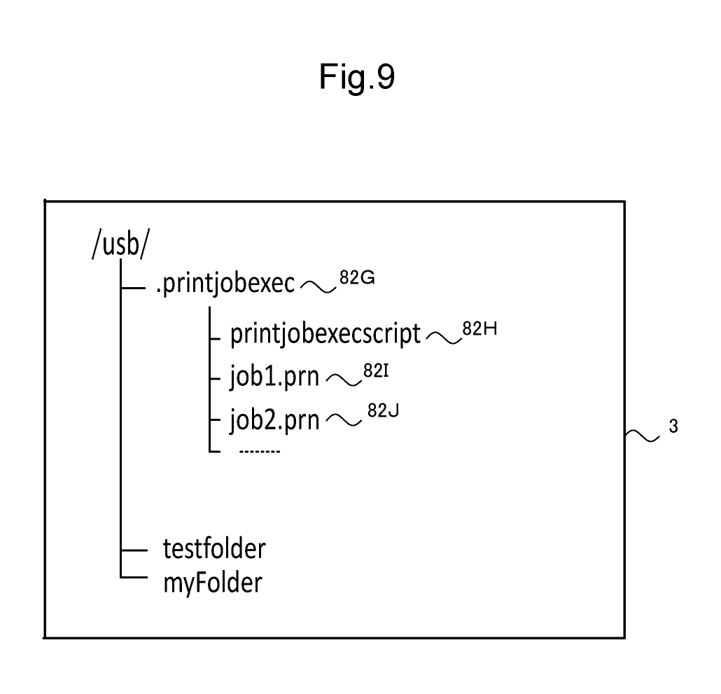

Referring to FIG. 9, the USB memory 3 contains a print execution folder 82G denoted by “.printjobexec”, including an auto-run program 82H denoted by “printjobexecscript”, a printing job 82I denoted by “job1.prn”, and a printing job 82J denoted by “job2.prn”. The print execution folder 82G and the auto-run program 82H are a hidden folder and a hidden program. Here, the controller 71 may cause the display unit 82 to display the printing job 82I and the printing job 82J.

In the image forming apparatus 2, the controller 21 decides whether the USB memory 3 has been connected to the external terminal 36 by the user (S14). Upon deciding that the USB memory 3 is not connected to the external terminal 36 (NO at S14), the controller 21 sets the image forming apparatus 2 to the standby mode.

In contrast, when the controller 21 decides that the USB memory 3 is connected to the external terminal 36 (YES at S14), the data reading unit 22 retrieves the auto-run program and the printing job from the USB memory 3 (S15: reading step). In the reading operation, the data reading unit 22 searches the hidden folder in the USB memory 3, and retrieves, upon detecting the print execution folder 82G, only the auto-run program and the printing job contained in the print execution folder 82G. In other words, even though document data of jpeg format or based on a word processor is stored in a folder other than the print execution folder 82G, for example “myFolder” shown in FIG. 9, the data reading unit 22 does not retrieve such document data. Therefore, the image forming apparatus 2 can execute the printing operation based only on the data desired by the user, in other words the printing job.

Thereafter, the decision unit 24 decides whether the printing unit 32 can execute the printing operation according to the printing condition included in the printing job retrieved by the data reading unit 22, on the basis of predetermined printing condition acceptable to the printing unit 32 (S16). For example, the decision unit 24 compares between the predetermined printing condition acceptable to the printing unit 32 and the printing condition included in the printing job retrieved as above, and decides whether the printing condition included in the printing job is acceptable, thus deciding whether the printing operation can be executed according to the printing condition included in the printing job.

When the decision unit 24 decides that the printing operation can be executed according to the printing condition included in the printing job retrieved as above (YES at S16), the controller 21 causes the printing unit 32 to execute the printing operation based on the printing job retrieved by the data reading unit 22, according to the auto-run program retrieved by the data reading unit 22 (S17: printing step).

Then the controller 21 decides whether the deletion command is included in the auto-run program retrieved by the data reading unit 22 (S18). In the case where the controller 21 has not detected the deletion command is not detected (NO at S18), the operation is finished. In the case where the deletion command is not detected, the auto-run program and the printing job remain stored in the USB memory 3. Therefore, the user can, for example, connect the USB memory 3 to another image forming apparatus, to also cause the other image forming apparatus to execute the printing operation based on the printing job stored in the USB memory 3.

Upon detecting the deletion command (YES at S18), the controller 21 causes the data deletion unit 23 to delete the auto-run program and the printing job from the USB memory 3 (S19). In the case where the deletion command is included in the program, the auto-run program and the printing job are deleted from the USB memory 3. Accordingly, the printing operation based on such printing job can no longer be executed, and therefore confidentiality of the printed material produced through the printing operation can be secured.

When the decision unit 24 decides that the printing operation is unable to be executed according to the printing condition included in the printing job retrieved as above (NO at S16), the controller 21 causes the display unit 351 to display a message requesting to instruct whether to change the printing condition so as to enable the printing unit 32 to execute the printing, and continue the printing operation according to the changed printing condition, or to suspend the printing operation based on the current printing job (S20).

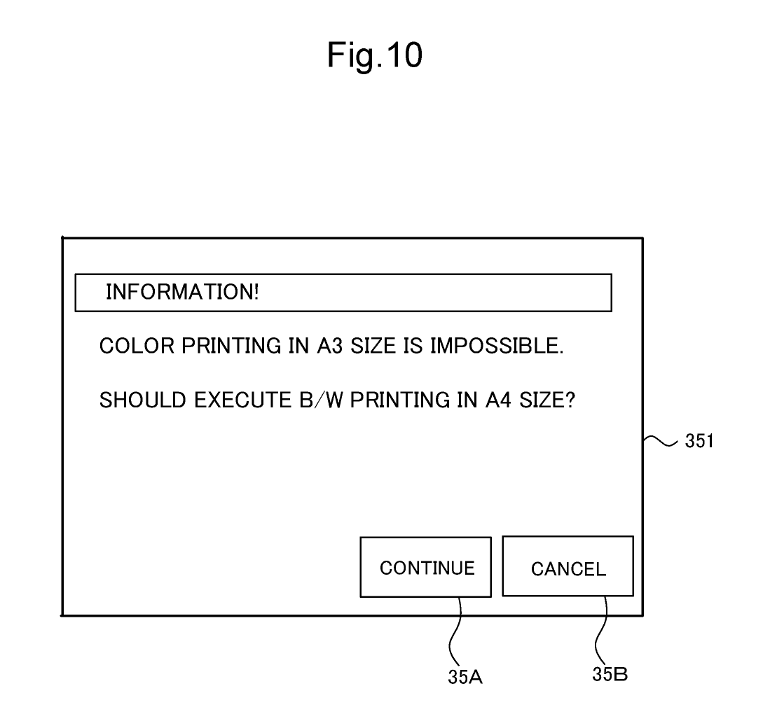

For example, in the case where the predetermined printing condition acceptable to the printing unit 32 specifies as A4 size and monochrome printing, while the printing job retrieved by the data reading unit 22 includes the printing condition specifying A3 and color printing, the controller 21 causes the display unit 351 to display, as shown in FIG. 10, a message notifying to the effect that the printing unit 32 is unable to execute color printing in the A3 size, and requesting to instruct whether to continue the printing operation according to a changed printing condition, for example monochrome printing in the A4 size.

Then the controller 21 decides whether the user has inputted the instruction to continue the printing operation according to the changed printing condition, through the operation reception unit 35 (S21). For example, the controller 21 decides whether the user has pressed a CONTINUE key 35A or a CANCEL key 35B, in the display screen shown in FIG. 10. Upon detecting that the user has pressed the CONTINUE key 35A (YES at S21), the controller 21 decides that the user has instructed to execute the printing operation according to the changed printing condition. The controller 21 then causes the printing unit 32 to execute the printing operation based on the printing job retrieved by the data reading unit 22, according to the changed printing condition (S22). Thus, the printing condition can be changed, so as to enable the printing unit 32 to execute the printing operation according to the changed printing condition. Therefore, even when the printing condition stored in the USB memory 3 is unacceptable to the printing unit 32, the printing operation based on the printing job stored in the USB memory 3 can be executed according to the changed printing condition, and the printed material produced through the printing operation can be provided to the user.

Upon detecting that the user has pressed the CANCEL key 35B (NO at S21), the controller 71 decides that the user has instructed to suspend the printing operation, and finishes the operation. After the printing operation is thus suspended and the operation is finished, the user can connect the USB memory 3 to another image forming apparatus capable of executing the printing operation according to the printing condition stored in the USB memory 3, to thereby cause the other image forming apparatus to execute the printing operation based on the printing job stored in the USB memory 3, thus obtaining the printed material produced through the printing operation.

As described thus far, in this embodiment the printing job generation unit 72 of the PC (information processing apparatus) 1 generates the printing job including the printing condition for the printing operation by the image forming apparatus 2, from the document data. The data writing unit 73 writes the auto-run program for causing the image forming apparatus 2 to automatically execute the printing operation, and the printing job, in the USB memory 3 (external memory) connected to the memory terminal 84. In the image forming apparatus 2, the data reading unit 22 retrieves the auto-run program and the printing job from the USB memory 3, when the USB memory 3 is connected to the external terminal 36. Further, the controller 21 causes the printing unit 32 to execute the printing operation based on the printing job retrieved by the data reading unit 22, according to the auto-run program retrieved by the data reading unit 22. As result, unlike known examples according to the background art, the image forming apparatus 2 can be made to automatically execute the printing operation, without the need to cause the user to take the trouble to operate the image forming apparatus 2 to set the condition for the printing operation.

Here, in the image forming system according to the background art, the user has to operate the image forming apparatus to set the condition for extracting unprinted data in the USB memory. In the image forming system according to the background art, in addition, the user has to set initial values of the printing condition in the image forming apparatus, in case the printing condition is unable to be acquired from the file.

In this embodiment, in contrast, the image forming apparatus can be made to automatically execute the printing operation, without the need to cause the user to operate the image forming apparatus to set the condition for the printing operation.

Hereunder, a second embodiment of the printing operation in the image forming system 100 will be described. The description of the same arrangement as that of the first embodiment will be omitted.

In the image forming apparatus 2 of the image forming system 100 according to the second embodiment, when the data reading unit 22 retrieves the auto-run program and the printing job from the USB memory 3, the controller 21 causes the display unit 351 to display the printing job. In addition, when the operation reception unit 35 receives the user's selection of the printing job to be printed by the printing unit 32, the controller 21 causes the printing unit 32 to execute the printing operation of only the printing job selected by the user.

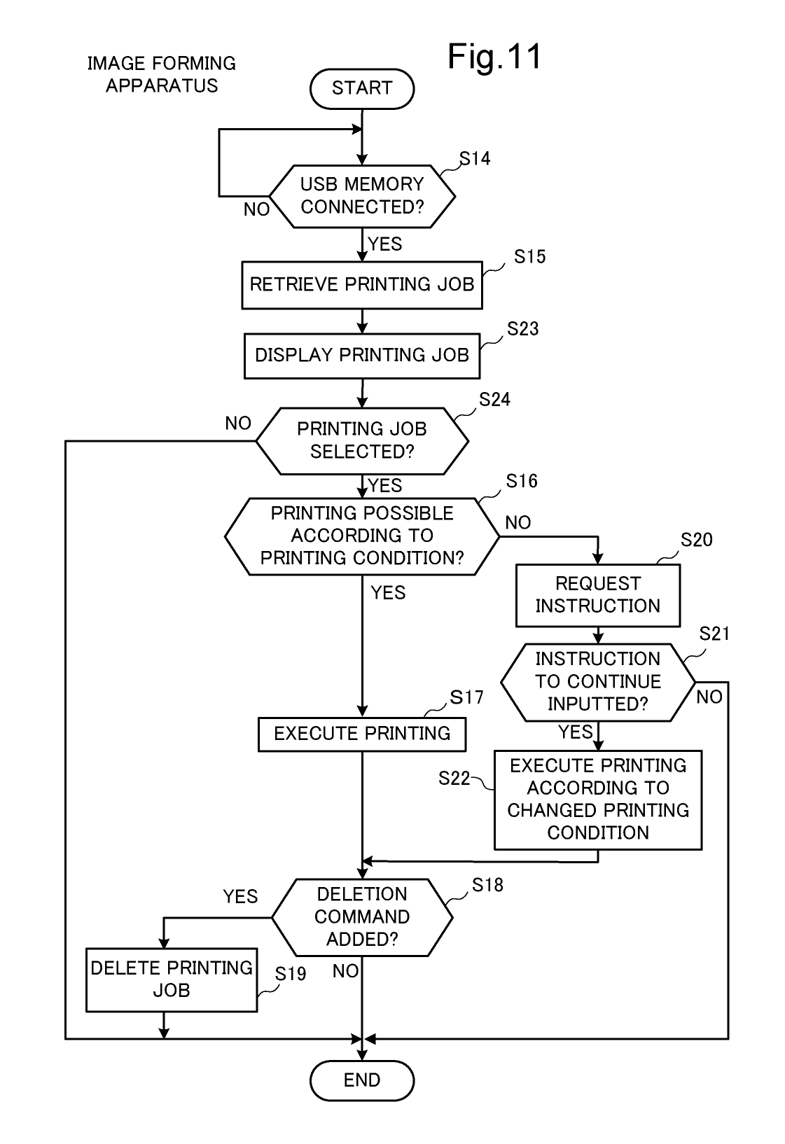

FIG. 11 is a flowchart showing a process performed by the image forming apparatus according to the second embodiment.

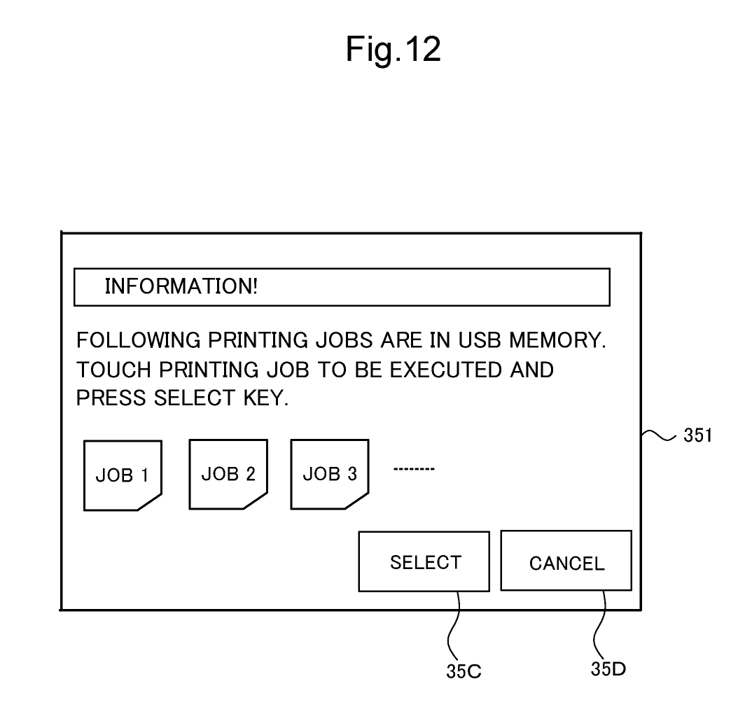

When the data reading unit 22 retrieves the auto-run program and the printing job from the USB memory 3, the controller 21 causes the display unit 351 to display the retrieved printing job (S23). For example as shown in FIG. 12, the controller 21 causes the display unit 351 to display all of the printing jobs retrieved from the USB memory 3, in other words all of the printing jobs stored in the USB memory 3, and a message requesting to select the printing job to be executed.

Then the controller 21 decides whether the user has selected the printing job (S24). For example, the controller 21 decides whether, in the display screen shown in FIG. 12, the user has pressed at least one job, and then whether the user has pressed a SELECT key 35C or a CANCEL key 35D. Upon detecting that the user has pressed at least one job and the SELECT key 35C (YES at S24), the controller 21 decides that at least one printing job has been selected, and that the execution of the printing operation based on the selected printing job has been instructed. Thereafter, the controller 21 performs the operation subsequent to S16 in the same way as the first embodiment, with respect to the selected printing job.

In contrast, in the case of detecting that the user has pressed the CANCEL key 35D (NO at S24), the controller 71 decides that the user has instructed to suspend the printing operation, and finishes the operation.

As described above, in this embodiment the printing job retrieved from the USB memory 3 is displayed on the display unit 351 in the image forming apparatus 2, so that the user can select one or more printing jobs out of those displayed on the display unit 35. In this embodiment, therefore the user can cause the image forming apparatus 2 to execute the printing operation of only the desired printing job.

Further, the configurations and arrangements described with reference to FIG. 1 to FIG. 12 are merely an embodiment of the disclosure, and in no way intended to limit the configurations and arrangements of the disclosure.

While the present disclosure has been described in detail with reference to the embodiments thereof, it would be apparent to those skilled in the art the various changes and modifications may be made therein within the scope defined by the appended claims.

What is claimed is:

1. An image forming system comprising:
an information processing apparatus; and
an image forming apparatus,
wherein the information processing apparatus includes:
a printing job generation unit that generates, on a basis of document data, a printing job including data of a printing condition for a printing operation to be executed by the image forming apparatus;
a memory terminal to which an external memory is connected;
a data writing unit that writes, in the external memory connected to the memory terminal, an auto-run program for causing the image forming apparatus to automatically execute the printing operation, and the printing job; and
a first controller that controls the data writing unit, and
the image forming apparatus includes:
a printing unit that executes the printing operation on a recording medium;
an external terminal to which the external memory is connected;
a data reading unit that retrieves the auto-run program and the printing job from the external memory, when the external memory is connected to the external terminal; and
a second controller that causes the printing unit, when the data reading unit retrieves the auto-run program and the printing job, to execute the printing operation based on the retrieved printing job, according to the retrieved auto-run program.

2. The image forming system according to claim 1,
wherein the information processing apparatus further includes:
a first operation reception unit for receiving an input of a user; and
a first display unit that displays information,
the first controller is configured to:
cause the first display unit to display, when the data writing unit is to write the auto-run program and the printing job in the external memory, a message urging the user to instruct whether to delete the auto-run program and the printing job from the external memory after the printing operation based on the printing job by the printing unit of the image forming apparatus is finished; and
cause the data writing unit to write in the external memory, when the first operation reception unit receives the instruction to delete the auto-run program and the printing job from the user, the auto-run program including a deletion command instructing to delete the auto-run program and the printing job from the external memory after the printing operation based on the printing job is finished, and the printing job,
the image forming apparatus further includes a data deletion unit that makes access to the external memory and deletes data in the external memory, and
the second controller causes the data deletion unit, upon detecting the deletion command in the auto-run program retrieved by the data reading unit, to delete the auto-run program and the printing job from the external memory.

3. The image forming system according to claim 2,
wherein the information processing apparatus further includes a data identification unit that makes access to the external memory when the data writing unit is to write the auto-run program and the printing job in the external memory, and decides whether another auto-run program and printing job are already stored in the external memory, and
the first controller is configured to:
cause the first display unit to display, when the data identification unit decides that the another auto-run program and printing job are stored in the external memory, a message requesting an instruction whether to save or delete the another auto-run program and printing job;
cause the data writing unit to write, when the first operation reception unit receives the instruction to save the another auto-run program and printing job from the user, the auto-run program and the printing job in the external memory, without deleting the another auto-run program and printing job from the external memory; and
cause the data writing unit to write, when the first operation reception unit receives the instruction to delete the another auto-run program and printing job from the user, the auto-run program and the printing job in the external memory, and also delete the another auto-run program and printing job from the external memory.

4. The image forming system according to claim 1,
wherein, when writing the auto-run program and the printing job in the external memory, the data writing unit collectively writes the auto-run program and the printing job in a print execution file, and stores a print execution folder including the print execution file, in a form of a hidden folder, in a storage region of the external memory, and
the second controller causes the printing unit, when the data reading unit retrieves the auto-run program and the printing job included in the hidden folder from the storage region of the external memory, to execute the printing operation based on the retrieved printing job according to the retrieved auto-run program.

5. The image forming system according to claim 1,
wherein the image forming apparatus further includes:
a second operation reception unit for receiving an input of a user;
a second display unit that displays information; and
a decision unit that decides, on a basis of a predetermined printing condition acceptable to the printing unit, whether the printing unit can execute the printing operation according to the printing condition included in the printing job retrieved by the data reading unit, and
the second controller is configured to:
cause the second display unit to display, when the decision unit decides that the printing unit is unable to execute the printing operation according to the retrieved printing condition, a message requesting an instruction whether to change the printing condition to another condition acceptable to the printing unit and continue the printing operation based on the retrieved printing job, or to suspend the printing operation based on the retrieved printing job;
cause the printing unit to execute the printing operation based on the retrieved printing job, when the second operation reception unit receives the instruction from the user to change the printing condition to another condition acceptable to the printing unit and continue the printing operation based on the retrieved printing job; and
cause the printing unit to suspend the printing operation based on the retrieved printing job, when the second operation reception unit receives the instruction from the user to suspend the printing operation.

6. The image forming system according to claim 1,
wherein the second controller is configured to:
cause the second display unit to display the printing job, when the data reading unit retrieves the auto-run program and the printing job; and
cause the printing unit, when the second operation reception unit receives from a user a selection of the printing job to be executed by the printing unit, to execute the printing operation based only on the selected printing job.

7. An image forming method to be executed by an image forming system including an information processing apparatus and an image forming apparatus, the method comprising:
a generating step includes generating, on a basis of document data, a printing job including data of a printing condition for a printing operation to be executed by the information processing apparatus;
a writing step includes writing, in an external memory, an auto-run program for causing the image forming apparatus to automatically execute the printing operation, and the printing job;
a reading step includes reading, the auto-run program and the printing job from the external memory, into the image forming apparatus; and
an executing step includes executing, the printing operation based on the retrieved printing job, according to the retrieved auto-run program.
